(19) United States
(12) Patent Application Publication
(10) Pub. No.: US 2024/0070594 A1
(43) Pub. Date: Feb. 29, 2024

(54) METHODS AND SYSTEMS FOR PREDICTING DATA QUALITY METRICS

(71) Applicant: Royal Bank of Canada, Toronto (CA)

(72) Inventors: Shrey Grover, Vancouver (CA); Chanvir Singh Nijjar, Brampton (CA); Arjun Sharma, Toronto (CA); Rebecca Chung, London (CA); Shravan Bharathulwar, Jersey City, NJ (US); Veera Raghavan Muthu Veeramani, Toronto (CA); Kevin E.C. Benson, New York City, NY (US)

(21) Appl. No.: 18/455,332

(22) Filed: Aug. 24, 2023

Related U.S. Application Data
(60) Provisional application No. 63/400,481, filed on Aug. 24, 2022.

(51) Int. Cl. G06Q 10/0639; G06Q 10/0635; G06Q 30/018

(52) U.S. Cl. CPC G06Q 10/06395; G06Q 10/0635; G06Q 10/06393; G06Q 30/018

(57) ABSTRACT

A data source is monitored. During the monitoring, an arrival at the data source of each of one or more sets of one or more features is detected. In response to detecting the arrival at the data source of at least a first set of one or more features of the one or more sets of one or more features, data is extracted from the first set of one or more features, data for at least a second set of one or more features of the one or more sets of one or more features is estimated, wherein the second set of one or more features has not yet arrived at the data source, and, based on the extracted data and the estimated data, a data quality metric is predicted.

### FIELD

The present disclosure relates to data processing and in particular to methods and systems for predicting data quality metrics.

### BACKGROUND

In capital markets, the reliance on the timely delivery of data is important for the purposes of compliance and regulatory reporting which includes the submission of data to relevant authorities. The relevant authorities, such as the Federal Reserve System, rely on the timeliness and accuracy of data submitted by financial services institutions for their own reporting and investigations.

Therefore, delays in the delivery of data to the financial services institution may hinder the finance team from compiling accurate data for their reports. Without the most up-to-date data, the finance team must take a best-effort approach and submit reports with estimated values. Reports with estimated values may not meet the expectations of the Federal Reserve System, and may expose the financial services institution to operational, reputational, and regulatory risks.

### SUMMARY

According to a first aspect of the disclosure, there is provided method of predicting a data quality metric, comprising performing, by one or more computer processors: monitoring a data source; during the monitoring, detecting an arrival of each of one or more sets of one or more features at the data source; and in response to detecting the arrival at the data source of at least a first set of one or more features of the one or more sets of one or more features: extracting data from the first set of one or more features; estimating data for at least a second set of one or more features of the one or more sets of one or more features, wherein the second set of one or more features has not yet arrived at the data source; and based on the extracted data and the estimated data, predicting the data quality metric.

The method may further comprise, in response to detecting the arrival at the data source of the second set of one or more features: extracting data from the second set of one or more features; and based on the data extracted from the second set of one or more features, updating the prediction of the data quality metric.

Predicting the data quality metric may comprise inputting the extracted data to a trained machine learning model.

The trained machine learning model may be a gradient-boosted tree model.

Estimating the data for the second set of one or more features may comprise estimating the data for the second set of one or more features using one or more of: a statistical method based on historical data; a regression model based on historical data; and a machine learning model based on historical data.

The one or more sets of one or more features may comprise one or more of: one or more end-of-day contract features; one or more number of records features; and one or more market-related features.

Detecting the arrival of at least the first set of one or more features may comprise: sequentially detecting the arrival of the one or more end-of-day contract features, the arrival of the one or more number of records features, and the arrival of the one or more market-related features.

The method may further comprise: in response to detecting the arrival at the data source of the second set of one or more features: estimating data for at least a third set of one or more features of the one or more sets of one or more features, wherein the third set of one or more features has not yet arrived at the data source; and based on the estimated data for the third set of one or more features, updating the prediction of the data quality metric; and in response to detecting the arrival at the data source of the third set of one or more features: extracting data from the third set of one or more features; and based on the data extracted from the third set of one or more features, further updating the data quality metric.

The first set of one or more features may comprise one or more end-of-day contract features. The second set of one or more features may comprise one or more number of records features. The third set of one or more features may comprise one or more market-related features.

Extracting the data from the first set of one or more features may comprise extracting one or more of: a source system associated with an end-of-day contract; a source region associated with the end-of-day contract; an arrival time associated with the end-of-day contract; a business date associated with the end-of-day contract; and a business day associated with the end-of-day contract.

Extracting the data from the second set of one or more features may comprise extracting a number of records associated with a number of records feature.

Extracting the data from the third set of one or more features may comprise extracting one or both of: a request time associated with a market-related feature; and a response time associated with the market-related feature.

Estimating the data for the second set of one or more features may comprise estimating a number of records associated with a number of records feature.

Estimating the data for the third set of one or more features may comprise estimating one or both of: a request time associated with a market-related feature; and a response time associated with the market-related feature.

The method may further comprise transmitting to one or more users a notification indicative of the prediction.

The data quality metric may comprise a metric indicative of a delay in data processing, and wherein the method further comprises: for each feature in each of the one or more sets of one or more features, identifying a Shapley value; comparing each Shapley value to a threshold; and based on the comparison, identifying a reason associated with the delay in the data processing.

Identifying the Shapley value may comprise, for each feature: inputting the feature to a trained regression or classification model; and identifying, using the trained regression or classification model, the Shapley value.

The data quality metric may comprise one or more: a metric indicative of a delay in data processing; a metric indicative of a completeness of data; and a metric indicative of an accuracy of data.

According to a further aspect of the disclosure, there is provided a computer-readable medium having stored thereon computer program code configured, when executed by one or more processors, to cause the one or more processors to perform a method comprising: monitoring a data source; during the monitoring, detecting an arrival of each of one or more sets of one or more features at the data source; and in response to detecting the arrival at the data source of at least a first set of one or more features of the one or more sets of one or more features: extracting data from the first set of one or more features; estimating data for at least a second set of one or more features of the one or more sets of one or more features, wherein the second set of one or more features has not yet arrived at the data source; and based on the extracted data and the estimated data, predicting the data quality metric.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 depicts a computer network that comprises a system for predicting data quality metrics, according to an embodiment of the disclosure.

FIG. 2 is a block diagram of a server comprised in the system depicted in FIG. 1, according to an embodiment of the disclosure.

FIG. 3 is a block diagram of various software and hardware components used for predicting data quality metrics, according to an embodiment of the disclosure.

FIG. 4 is a first flow diagram of a method of predicting delays in data processing, according to an embodiment of the disclosure.

FIG. 5 is a second flow diagram of a method of predicting delays in data processing, according to an embodiment of the disclosure.

FIG. 6 is a flow diagram depicting a user's interaction with a user interface associated with a system for predicting delays in data processing, according to an embodiment of the disclosure.

### DETAILED DESCRIPTION

The present disclosure seeks to provide novel methods and systems for predicting data quality metrics. While various embodiments of the disclosure are described below, the disclosure is not limited to these embodiments, and variations of these embodiments may well fall within the scope of the disclosure which is to be limited only by the appended claims.

Generally, according to embodiments of the disclosure, there are described methods and systems for predicting data quality metrics. A data quality metric may comprise, for example, a metric indicative of a delay in a processing of the data (in other words, a metric indicative of the timeliness of the data), a metric indicative of the completeness of the data, and a metric indicative of the accuracy of the data. Within the scope of this disclosure, other data quality metrics may be predicted.

For example, using one or more computer processors, a data source may be monitored for the arrival of data. During the monitoring, a delivery of a first set of features at the data source may be detected. The first set of features may include, for example, features relating to trading positions data delivered at the end of a day (such trading positions data may be referred to throughout this disclosure as “end-of-day contract data” and may be comprised in an “end-of-day contract file”). In response to detecting the delivery of the first set of features, data may be extracted from the first set of features. For instance, the first set of features may be processed by the one or more computer processors to identify data indicative of a business date, a business day (day of the week), and an arrival time of the end-of-day contract data, as well as a source system and a source region associated with the end-of-day contract data. Data relating to one or more further sets of features that have not yet arrived at the data source may then be estimated (for example, based on historical data). The one or more further sets of features may include, for example, data relating to a number of records contained in the end-of-day contract data, and market data. Based on the data extracted from the first set of features, and based on the estimated data relating to the one or more further sets of features that have not yet arrived at the data source, a delay in data processing may be predicted and communicated to one or more interested parties. The data processing may refer to the processing required to generate a risk-related report for downstream consumers. Therefore, the time needed to process the risk-related report is based on when the end-of-day contract file, the number of records data, and the market data are received, as described in further detail below. Furthermore, by determining a likely delay to the data processing, the expected completion of the data processing may be adjusted based on the determined delay.

While the above example has been described in the context of predicting a delay in data processing based on known data and estimated data, other data quality metrics may be predicted, such as a metric indicative of the completeness of the data, or a metric indicative of the accuracy of the data. Such other data quality metrics may be predicted by processing different sets of features.

Systems described herein may therefore be configured to act as a predictive tool that informs users of likely delays in data processing, and may furthermore identify reasons for any potential delays associated with the data processing. The systems described herein may be powered by one or more machine learning models, such as a gradient-boosted, tree-based ensemble model (for instance LightGBM or XGBoost) or a neural network model. The results may be displayed on a dashboard of a computer display, for example, and users may be notified (for example, by e-mail) when new/updated delays have been calculated. Other data analytics may be available via the dashboard. For example, trends in delays over time, or summary statistics, may be calculated and displayed to users.

By predicting potential delays in data processing, users may accelerate their decision-making process to remediate issues for timely arrivals. For example, the predictions from the model can be used to build a decision support system that helps users make informed decisions. For instance, if the model predicts a delay, users can take proactive measures such as identifying root causes for recurring delays, prioritizing certain data, or planning for rollover of data from the previous business day. Furthermore, root cause analysis provided by the systems described herein can assist users in the investigation of why a delay occurred. For example, for a given prediction, the most influential features may be determined by computing Shapley values for each feature.

Furthermore, by using one or more of the methods described herein, users may be notified of potential delays earlier in the data processing lifecycle, and may take proactive measures to manage their time accordingly.

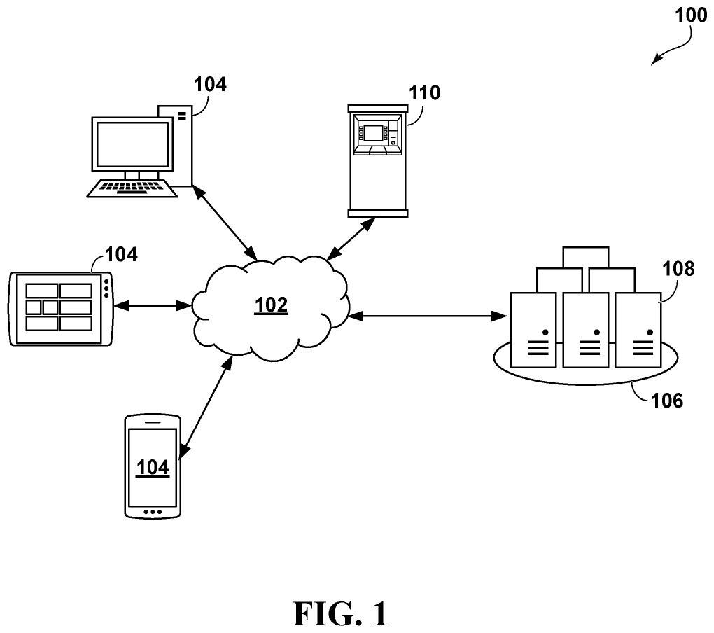

Referring now to FIG. 1, there is shown a computer network 100 that comprises an example embodiment of a system 100 for predicting delays in data processing. More particularly, computer network 100 comprises a wide area network 102 such as the Internet to which various user devices 104, an ATM 110, and a data center 106 are communicatively coupled. Data center 106 comprises a number of servers 108 networked together to collectively perform various computing functions. For example, in the context of a financial institution such as a bank, data center 106 may host online banking services that permit users to log in to servers 108 using user accounts that give them access to various computer-implemented banking services, such as online fund transfers. Furthermore, individuals may appear in person at ATM 110 to withdraw money from bank accounts controlled by data center 106.

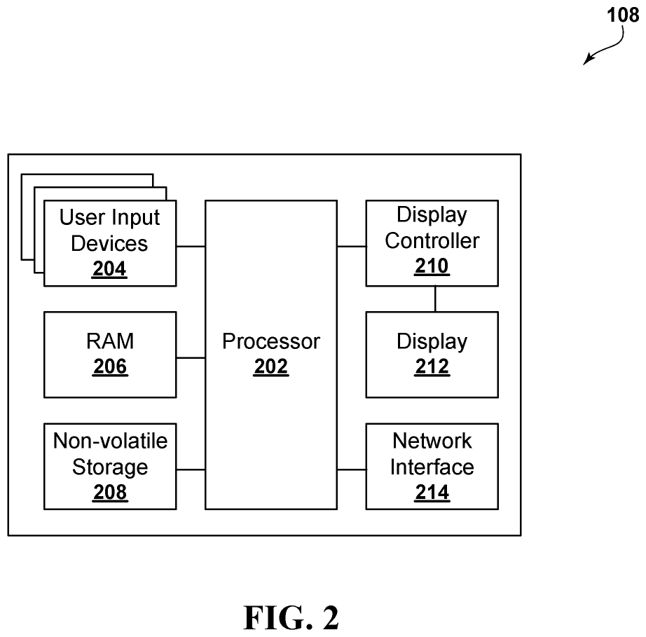

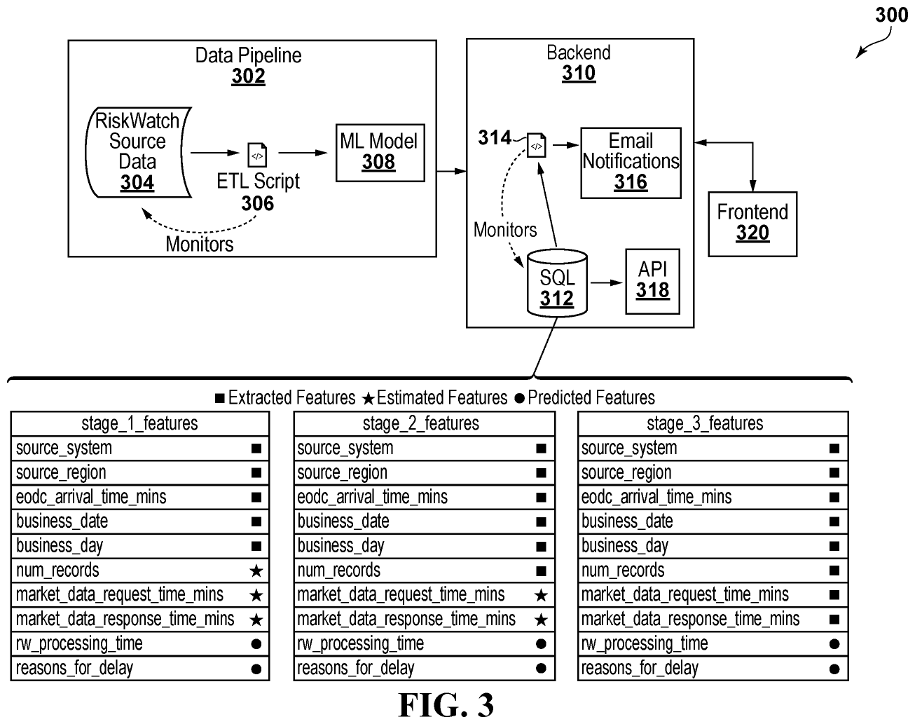

Referring now to FIG. 2, there is depicted an example embodiment of one of the servers 108 that is comprised in data center 106. The server 108 comprises a processor 202 that controls the server 108's overall operation. Processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with wide area network 104 and the other servers 108 in the data center 106. Non-volatile storage 208 has stored on it computer program code that is loaded into RAM 206 at runtime and that is executable by processor 202. When the computer program code is executed by processor 202, processor 202 causes the server 108 to implement one or more methods for predicting data quality metrics, such as described in more detail in connection with FIGS. 3-6 below. Additionally or alternatively, servers 108 may collectively perform the one or more methods for predicting data quality metrics using distributed computing. While the system depicted in FIG. 2 is described specifically in respect of connection with one of the servers 108, analogous versions of the system may also be used for user devices 104.

Referring now to FIG. 3, there are depicted various components of a system 300 for predicting delays in data processing. In particular, system 300 includes a data pipeline 302, a back-end infrastructure 310, and a front-end dashboard 320. While system 300 is described in the context of being used to predict a delay in data processing, as described above, system 300 may be used to predict other data quality metrics, by processing different sets of features.

At each of one or more checkpoints, a Python script (e.g. an Extract, Transform, Load (ETL) Script) 306 first checks for the arrival of data at a data source 304 (including a database and log files). Once data is received at data source 304, one or more features within the received data are identified, and data within these features is extracted using Python script 306 and passed to a machine learning model 308. A checkpoint may be a point in time at which a specific set of data is determined to have been received at data source 304. For example, Python script 306 may be configured to determine when each of (1) end-of-day contract data, (2) number of records data, and (3) market data is delivered at data source 304. The arrival of each of these sets of features at data source 304 may constitute a checkpoint. Following the receipt of each set of features at data source 304, machine learning model 308 is configured to predict a delay in data processing (or update a previously-estimated delay), as described in further detail below.

In particular, machine learning model 308 outputs an estimation of data for features that have not yet arrived at data source 304. More generally, data of features that have not yet arrived at data source 304 can be imputed using regression or machine learning models that capture the relationship between the data for the features whose data is known as well as the features whose data is still missing, based on the historical data for these features. Alternatively, estimation of data for features that have not yet arrived at data source 304 may be performed using any of a number of statistical methods based on historical data for the features whose data is known as well as the features whose data is still missing. For instance, data missing for features that have not yet arrived at data source 304 can be estimated by sampling and aggregating values from empirical probability distributions based on the historical data, or from kernel density estimates which are functional representations of the historical data.

For each checkpoint, the data extracted from features received at data source 304, the estimated data for features that have still not arrived at source 304, and associated predictions of delays in data processing, are stored in separate tables in an application database 312. A Python script 314 periodically checks application database 312 for new database entries that are made in response to new features arriving at data source 304 and new potential delays being calculated for any feature that has not yet arrived at data source 304. In response to Python script 314 detecting a new delay prediction being entered into application database 312, Python script 314 triggers e-mail notifications 316 to be transmitted to each user registered with system 300. Over time, historical trends in delays may be observed and displayed on a dashboard 320 that is coupled to back-end infrastructure 310. Dashboard 320 may extract data from application database 312 via an application programming interface (API) 318.

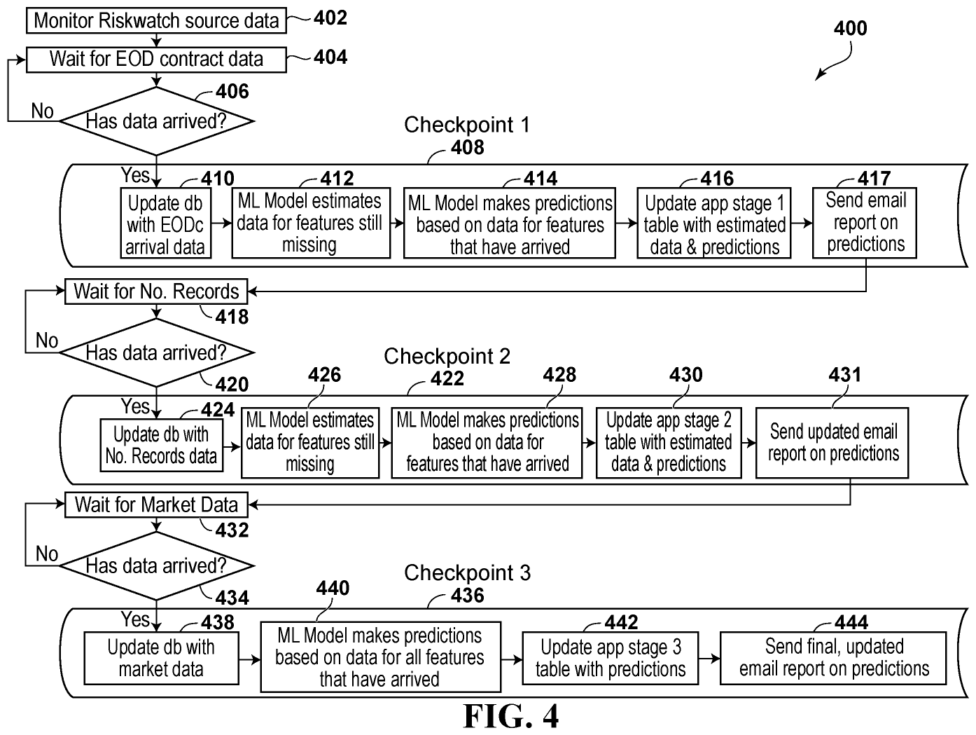

Turning to FIG. 4, there is now described a first flow diagram of a method of predicting a delay in data processing, according to an embodiment of the disclosure. As described above, system 300 may inform end users about predicted delays in the data processing at a number of different checkpoints. According to the embodiment shown in FIG. 4, these checkpoints include: the receipt of an end-of-day contract file at data source 304; the receipt of a number of records at data source 304; and the receipt of market-related data at data source 304. After each new set of features arrives at data source 304, the predictions of delays in the data processing become more accurate.

At block 402, data source 304 is monitored for the arrival of an input file (e.g. an end-of-day contract file).

At block 404, system 300 waits for the arrival of the end-of-day contract file at data source 304.

At block 406, system 300 determines whether the end-of-day contract file has arrived at data source 304. If the end-of-day contract file has not arrived at data source 304, the process returns to block 406. If the end-of-day contract file has arrived at data source 304, the process proceeds to first checkpoint 408.

At block 410, database 312 is updated with the arrival time of the end-of-day contract file.

At block 412, machine learning model 308 processes the end-of-day contract file. In particular, machine learning model 308 extracts data from the end-of-day contract file. The extracted data includes data indicative of a source system associated with the end-of-day contract file, a source region associated with the end-of-day contract file, an arrival time of the end-of-day contract file, an arrival date of the end-of-day contract file, and a business day on which the end-of-day contract file arrived. Machine learning model 308 then estimates the data for features that have not yet arrived at data source 304, i.e., data indicative of the number of records in the end-of-day contract file, and data indicative of a request time associated with the market data and a response time associated with the market data.

As described above, estimation of the missing data (i.e., the data of features that have not yet arrived at data source 304) may be performed using any of a number of statistical methods based on historical data for both features that have arrived at data source 304 as well as features that have not yet arrived at data source 304). Alternatively, the estimation of the missing data can be imputed using regression or machine learning models (such as machine learning model 308) that capture the relationship between the data for both features that have arrived at data source 304 as well as features that have not yet arrived at data source 304, based on the historical data for these features. The machine learning model may be implemented using any industry-standard or other highly-performant statistical learning method, such as ensemble tree or neural network algorithms. In general, the model is trained using a historical dataset that is representative of the conditions and data environment in which it will be used. As part of this process, and in order to optimize model performance, the model is tuned with respect to various model hyperparameters. Once the model is trained and tuned, it can then be used for inference or prediction based on live conditions.

At block 414, based on the data extracted from the features relating to the end-of-day contract file, and based on the estimated data of those features that have not yet arrived at data source 304, machine learning model 308 predicts the delay in the data processing required for generation of a risk-related report, and infers one or more reasons for the delay.

According to some embodiments, the machine learning model may be a regression model or a classification model, depending on the desired prediction type. For instance, the model may be used to predict the Service Level Agreement (SLA) status (e.g., on-time, late, or breach), in which case the model may be trained as a classification model. Alternatively, the model may be used to predict the magnitude of the delay (e.g., number of minutes past the deadline), in which case the model may be trained as a regression model. In addition, the model may be used to yield insights as to the primary drivers of delays. For example, the most influential features may be determined by computing Shapley values for each feature, and these most influential features may relate to the primary reason(s) for the delay. Shapley values are a statistical measure that indicate the relative importance, as well as the impact on output predictions, of various input features.

At block 416, database 312 is updated with the estimated data for missing feature(s) (i.e., features not yet detected as having arrived at data source 304) and predicted delay calculated at block 414.

At block 417, one or more e-mail notifications are transmitted to one or more users to advise them of the predicted delay.

At block 418, system 300 waits for the arrival of the number of records feature at data source 304.

At block 420, system 300 determines whether the number of records feature has arrived at data source 304. If the number of records feature has not arrived at data source 304, the process returns to block 418. If the number of records feature has arrived at data source 304, the process proceeds to second checkpoint 422.

At block 424, database 312 is updated with the number of records feature and its associated arrival time.

At block 426, machine learning model 308 processes the number of records feature. In particular, machine learning model 308 extracts data from the number of records feature. The extracted data is indicative of the number of records in the end-of-day contract file. The extracted data replaces the estimated data that was estimated at block 412.

At block 428, based on the extracted data relating to the end-of-day contract file and the extracted data indicative of the number of records, and based on the estimated request time associated with the market data and estimated response time associated with the market data, machine learning model 308 updates the prediction of the delay in the data processing required for the generation of the risk-related report, and infers one or more reasons for the delay, as described above.

At block 430, database 312 is updated with the extracted data indicative of the number of records as well as the updated delay calculated at block 428.

At block 431, one or more e-mail notifications are transmitted to one or more users to advise them of the update in the predicted delay.

At block 432, system 300 waits for the arrival of the market data feature at data source 304.

At block 434, system 300 determines whether the market data feature has arrived at data source 304. If the market data feature has not arrived at data source 304, the process returns to block 432. If the market data feature has arrived at data source 304, the process proceeds to third checkpoint 436.

At block 438, database 312 is updated with the market data feature and its associated arrival time.

At block 440, machine learning model 308 processes the market data feature. In particular, machine learning model 308 extracts market data from the market data feature. The extracted market data is indicative of the request time associated with the market data, and the response time associated with the market data. Based on this extracted data, and based on all previously extracted data (i.e., based on the extracted data relating to the end-of-day contract file, the number of records feature, and the market data feature), machine learning model 308 updates the prediction of the delay in the data processing required for the generation of the risk-related report, and infers one or more reasons for the delay.

At block 442, database 312 is updated with the updated delay calculated at block 440.

At block 444, one or more e-mail notifications are transmitted to one or more users to advise them of the update in the predicted delay.

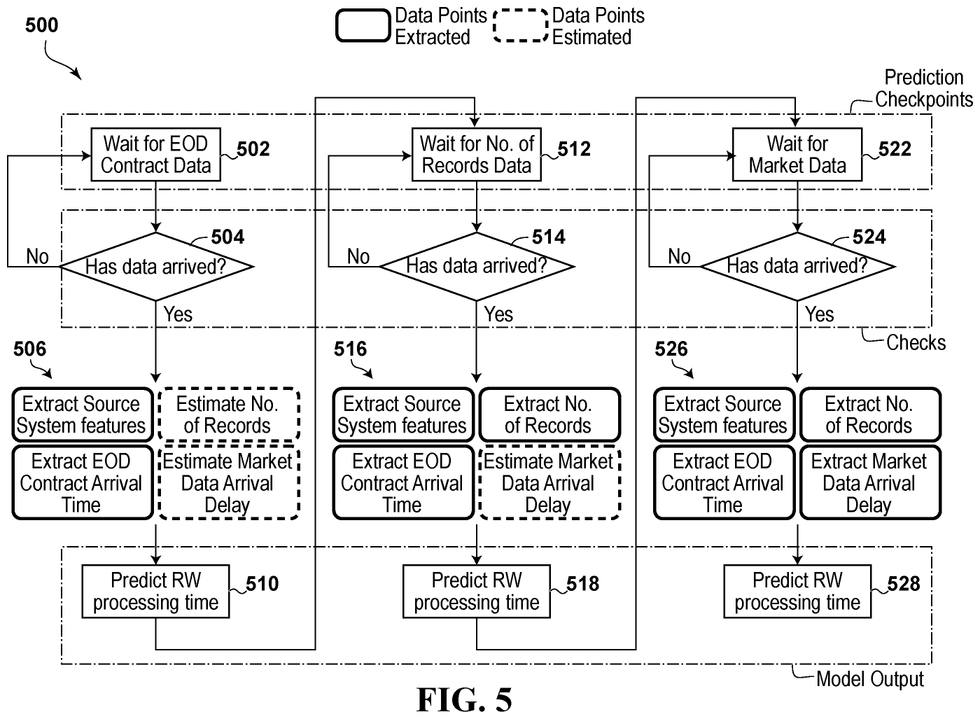

Turning to FIG. 5, there is now described a second flow diagram of a method of predicting a delay in data processing, according to an embodiment of the disclosure.

At block 502, system 300 waits for the arrival of an end-of-day contract file.

At block 504, system 300 determines whether the end-of-day contract file has arrived at data source 304. If the end-of-day contract file has arrived at data source 304, the process moves to block 506. If the end-of-day contract file has not arrived at data source 304, the process returns to block 502.

At block 506, system 300 extracts source and system data from the end-of-day contract file. The source data provides an indication of a source region/geographic information associated with trades contained in the end-of-day contract file, and the system data provides an indication of the system that generated the end-of-day contract file. System 300 then estimates a number of records in the end-of-day contract file, a request time associated with the market data, and a response time associated with the market data (for example, using a statistical method, or a regression or machine learning model, applied to historical data).

At block 510, based on the extracted data, and based on the estimates obtained at block 506, system 300 predicts a delay in the data processing required for the generation of a risk-related report.

At block 512, system 300 waits for the arrival of a number of records feature.

At block 514, system 300 determines whether the number of records feature has arrived at data source 304. If the number of records feature has arrived at data source 304, the process moves to block 516. If the number of records feature has not arrived at data source 304, the process returns to block 512.

At block 516, system 300 extracts the number of records from the number of records feature. The extracted number of records replaces the estimated number of records calculated at block 506. The estimated request time associated with the market data and response time associated with the market data (calculated at block 412) are re-used.

At block 518, based on the extracted number of records, and the estimated request time associated with the market data and response time associated with the market data, system 300 updates the prediction of the delay in the data processing required for the generation of a risk-related report.

At block 522, system 300 waits for the arrival of a market data feature.

At block 524, system 300 determines whether the market data feature has arrived at data source 304. If the market data feature has arrived at data source 304, the process moves to block 526. If the market data feature has not arrived at data source 304, the process returns to block 522.

At block 526, system 300 extracts, from the market data feature, a request time and a response time (i.e., system 300 determines a delay between a request for the market data and a delivery of the requested data). The extracted request time and response time replace the estimated request time and estimated response time calculated above.

At block 528, based on the extracted source and system features, based on the extracted number of records, and based on the extracted request time and response time (i.e., the determined delay in the arrival of the market data), system 300 updates the prediction of the delay in the data processing required for the generation of the risk-related report.

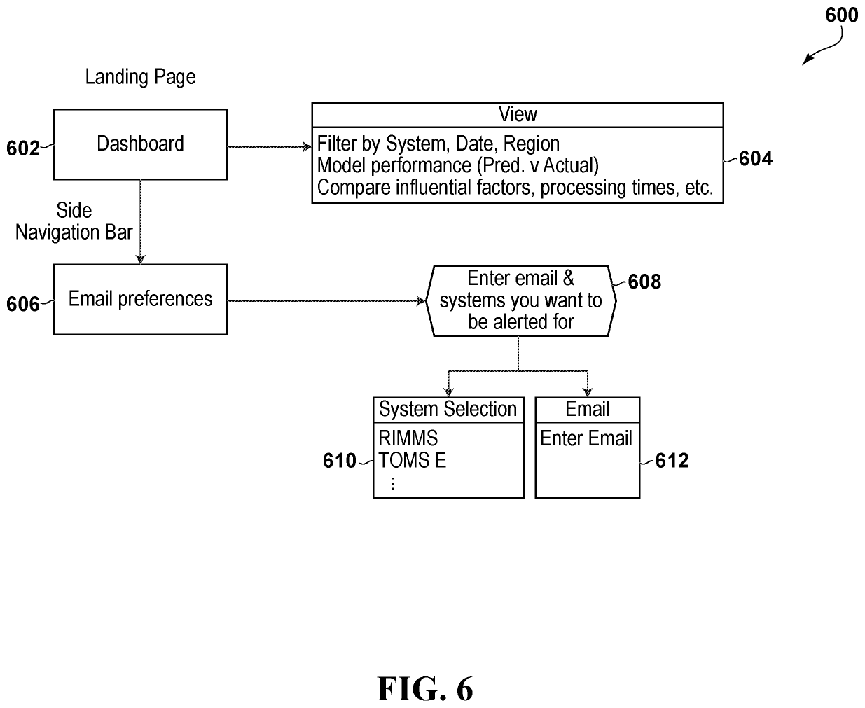

Turning to FIG. 6, there is shown a flow diagram illustrating an example sequence of steps that may be taken by a user interacting with dashboard 320.

At block 602, a user is taken to a landing page.

At block 604, the user may view any of various outputs of system 300. For example, the user is provided with the option to view any of various historical trends based on past delays associated with data processing. For example, various systems can be investigated based on the average processing times or influencing factors behind those processing times. A significant delivery delay may be a delay that exceeds a preset threshold. The user may also be provided with the option to compare predicted delays in data processing with actual delays in data processing.

At block 606, a user may select to update their e-mail notification preferences.

At block 608, the user is taken to a page where they may enter the systems on which they wish to receive updates (block 610), and where they may enter one or more e-mail addresses for receiving such updates (block 612).

Any of the processors used in the foregoing embodiments may comprise, for example, a processing unit (such as a processor, microprocessor, or programmable logic controller) or a microcontroller (which comprises both a processing unit and a non-transitory computer readable medium). Examples of computer-readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of predicting a data quality metric, comprising performing, by one or more computer processors:
monitoring a data source;
during the monitoring, detecting an arrival of each of one or more sets of one or more features at the data source; and
in response to detecting the arrival at the data source of at least a first set of one or more features of the one or more sets of one or more features:
extracting data from the first set of one or more features;
estimating data for at least a second set of one or more features of the one or more sets of one or more features, wherein the second set of one or more features has not yet arrived at the data source; and
based on the extracted data and the estimated data, predicting the data quality metric.

2. The method of claim 1, further comprising:
in response to detecting the arrival at the data source of the second set of one or more features:
extracting data from the second set of one or more features; and
based on the data extracted from the second set of one or more features, updating the prediction of the data quality metric.

3. The method of claim 1, wherein predicting the data quality metric comprises inputting the extracted data to a trained machine learning model.

4. The method of claim 3, wherein the trained machine learning model is a gradient-boosted tree model.

5. The method of claim 1, wherein estimating the data for the second set of one or more features comprises estimating the data for the second set of one or more features using one or more of: a statistical method based on historical data; a regression model based on historical data; and a machine learning model based on historical data.

6. The method of claim 1, wherein the one or more sets of one or more features comprise one or more of:
one or more end-of-day contract features;
one or more number of records features; and
one or more market-related features.

7. The method of claim 6, wherein detecting the arrival of at least the first set of one or more features comprises:
sequentially detecting the arrival of the one or more end-of-day contract features, the arrival of the one or more number of records features, and the arrival of the one or more market-related features.

8. The method of claim 2, further comprising:
in response to detecting the arrival at the data source of the second set of one or more features:
estimating data for at least a third set of one or more features of the one or more sets of one or more features, wherein the third set of one or more features has not yet arrived at the data source; and
based on the estimated data for the third set of one or more features, updating the prediction of the data quality metric; and
in response to detecting the arrival at the data source of the third set of one or more features:
extracting data from the third set of one or more features; and
based on the data extracted from the third set of one or more features, further updating the data quality metric.

9. The method of claim 8, wherein:
the first set of one or more features comprises one or more end-of-day contract features;
the second set of one or more features comprises one or more number of records features; and
the third set of one or more features comprise one or more market-related features.

10. The method of claim 8, wherein extracting the data from the first set of one or more features comprises extracting one or more of: a source system associated with an end-of-day contract; a source region associated with the end-of-day contract; an arrival time associated with the end-of-day contract; a business date associated with the end-of-day contract; and a business day associated with the end-of-day contract.

11. The method of claim 8, wherein extracting the data from the second set of one or more features comprises extracting a number of records associated with a number of records feature.

12. The method of claim 8, wherein extracting the data from the third set of one or more features comprises extracting one or both of: a request time associated with a market-related feature; and a response time associated with the market-related feature.

13. The method of claim 8, wherein estimating the data for the second set of one or more features comprises estimating a number of records associated with a number of records feature.

14. The method of claim 8, wherein estimating the data for the third set of one or more features comprises estimating one or both of: a request time associated with a market-related feature; and a response time associated with the market-related feature.

15. The method of claim 1, further comprising transmitting to one or more users a notification indicative of the prediction.

16. The method of claim 1, wherein the data quality metric comprises a metric indicative of a delay in data processing, and wherein the method further comprises:
for each feature in each of the one or more sets of one or more features, identifying a Shapley value;
comparing each Shapley value to a threshold; and
based on the comparison, identifying a reason associated with the delay in the data processing.

17. The method of claim 16, wherein identifying the Shapley value comprises, for each feature:
inputting the feature to a trained regression or classification model; and
identifying, using the trained regression or classification model, the Shapley value.

18. The method of claim 1, wherein the data quality metric comprises one or more:
a metric indicative of a delay in data processing;
a metric indicative of a completeness of data; and
a metric indicative of an accuracy of data.

19. A computer-readable medium having stored thereon computer program code configured, when executed by one or more processors, to cause the one or more processors to perform a method comprising:
monitoring a data source;
during the monitoring, detecting an arrival of each of one or more sets of one or more features at the data source; and
in response to detecting the arrival at the data source of at least a first set of one or more features of the one or more sets of one or more features:
extracting data from the first set of one or more features;
estimating data for at least a second set of one or more features of the one or more sets of one or more features, wherein the second set of one or more features has not yet arrived at the data source; and
based on the extracted data and the estimated data, predicting the data quality metric.
